(19) United States
(12) Patent Application Publication
(10) Pub. No.: US 2009/0259569 A1
(43) Pub. Date: Oct. 15, 2009

(54) METHOD AND SYSTEM FOR INVENTORY MANAGEMENT

(76) Inventors: Jaime Narea, Parkland, FL (US); Carlos Polo, Miami, FL (US)

Correspondence Address: K&L GATES LLP, 535 SMITHFIELD STREET, PITTSBURGH, PA, 15222, US

(21) Appl. No.: 12/100,140

(22) Filed: Apr. 9, 2008

(51) Int. Cl. G06Q 10/00

(52) U.S. Cl. 705/28; 235/385

(57) ABSTRACT

A method and system for inventory management includes a communication device at each of a plurality of point of sale locations communicatively coupled to a distribution center. Each communication device stores initial inventory information; periodically determines whether an item has been sold, and when an item has been sold, stores the sold item information; stores accumulated inventory information comprising the initial inventory information and the sold item information; and transmits the accumulated inventory information. The distribution center receives the accumulated inventory information; evaluates a current inventory at each of the point of sale locations using the received accumulated inventory information; identifies a demand information comprising an adequate supply of items to ship to each of the point of sale locations using the associated evaluated current inventory; and programs suppliers to meet the point of sale locations' needs using the demand information.

### TECHNICAL FIELD OF THE INVENTION

The present application relates generally to inventory management and, more particularly, to the use of wireless communication for real time management of inventory of a plurality of locations.

### BACKGROUND

As products are distributed to retailers and consumers through a distribution system, products are replenished in anticipation of future demands by the various retailers and consumers of the products. In current distribution systems, monitoring consumer and retailer product demand and replenishing products according to such demand is done utilizing manual operations. For example, in some systems, retailers and/or consumers manually provide their current and/or forecasted product needs to a distributor. In other systems, a distributor tracks historical product demands for each of their customers in order to forecast current and/or future demands.

Distribution of mass consumption items such as food, drinks, electronic products, and the like add a further dimension of challenges in that such items are typically sold in a variety of small stores without sophisticated methods for identifying current demands. Further, it is more difficult to forecast consumer demand as such demands can change unexpectedly due to changes in the environment, culture, weather, and the like. Small, privately owned retail stores further stock only minimum quantities of items due to their inability to invest in large inventory costs.

In most systems, distribution of these mass consumption items to such small retail stores is done via delivery trucks. Each truck has a given route for distribution. The quantity of each item which each truck carries is estimated because the distribution process and system does not have any knowledge of the true item demand per store. The volume estimation of any item that a given truck carries for distribution is calculated based on the experience of past sales volume and consumption. Detrimentally, when the volume estimate is inaccurate, a truck can include the wrong quantities of one or more items, thereby either bringing back too many of one or more items, and/or not having enough of one or more items required by the customers of the truck's distribution route.

### SUMMARY

In one general respect, the present application is directed to a system for inventory management that includes a communication device at each of a plurality of point of sale locations and a distribution center communicatively coupled to each of the communication devices. Each communication device is programmed to store an initial inventory information, periodically determine whether an item has been sold, and when an item has been sold, store the sold item information. Each communication device is further programmed to store an accumulated inventory information comprising the initial inventory information and the sold item information, and transmit the accumulated inventory information at a defined interval to a distribution center. The distribution center is programmed to receive the accumulated inventory information from each of a plurality of point of sale locations, evaluate a current inventory at each of the point of sale locations using the respective received accumulated inventory information, identify a demand information comprising an adequate supply of items to ship to each of the point of sale locations using the associated evaluated current inventory, and program one or more suppliers within a supply chain to meet the point of sale locations' needs using the demand information.

This Summary is intended be briefly outline certain embodiments of the subject application. It should be understood that the subject application is not limited to the embodiments disclosed in this Summary, and is intended to cover modifications that are within its spirit and scope, as defined by the claims. It should be further understood that this Summary should not be read or construed in a manner that will act to narrow the scope of the claims

### DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a distribution system for inventory management according to various embodiments.

FIG. 2 is a block diagram illustrating the communication device 110 according to various embodiments.

FIG. 3 is a flowchart illustrating the operation of the distribution system of FIG. 1 according to various embodiments.

FIG. 4 is an illustrative example of a graphic user interface for use in the operation of the distribution system of FIG. 1 according to various embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of exemplary embodiments described hereinbelow.

The apparatus and method components have been represented where appropriate by conventional symbols in the drawings, showing only those specific details that are pertinent to understanding the exemplary embodiments described hereinbelow so as not to obscure the disclosure with details that will be readily apparent to those of ordinary skill in the art having the benefit of the description herein.

### DETAILED DESCRIPTION

A system and method to provide accurate, current inventory demand per customer prior to distribution of such items is provided herein. The distribution system thereby provides each truck with the capability to deliver to each customer on its route the accurate quantities of items required for replenishment of retailer inventory at any given moment in time.

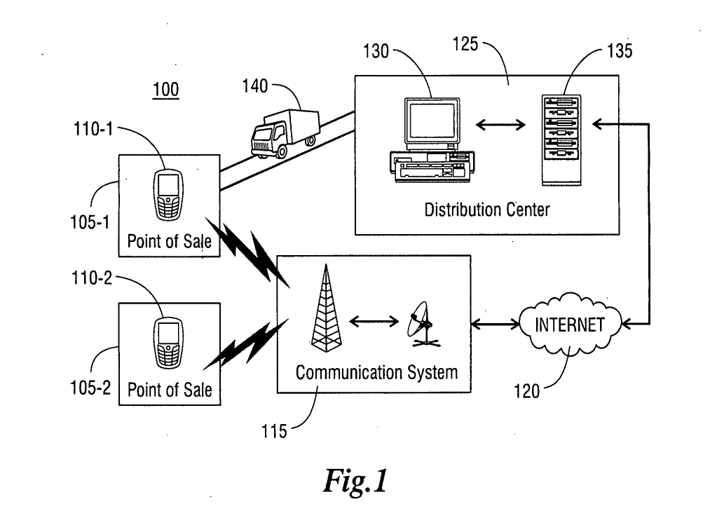

FIG. 1 is a block diagram of a distribution system 100 for inventory management according to various embodiments. As illustrated, the distribution system 100 includes one or more point of sale locations 105-n such as the point of sale locations 105-1 and 105-2 as illustrated. It will be appreciated by those of ordinary skill in the art that two point of sale locations 105-n are illustrated in FIG. 1 for example purposes only, and that any number of point of sale locations can be included within the distribution system 100. Each point of sale location 105-n may be a business or other place where a product can be purchased. The point of sale location 105-n, for example, can be a convenience store, a grocery store, a retail store, a warehouse store, or any other such place in which goods can be purchased.

According to various embodiments, each point of sale location 105-n has a communication device 110-n. For example, as illustrated in FIG. 1, the point of sale location 105-1 includes a communication device 110-1 and the point of sale location 105-2 includes a communication device 110-2. It will be appreciated by one of ordinary skill in the art that each of the communication devices 110-n, in certain embodiments, can be a mobile communication device such as a mobile cellular telephone, a mobile radio data terminal, a mobile cellular telephone having an attached data terminal, a two messaging device, or an equivalent. Similarly, each of the communication devices 110-n, in certain embodiments, can be a fixed communication device such as a landline telephone, a computer terminal with communication capabilities, or an equivalent. In the following description, the term “communication device” refers to any of the devices mentioned above or an equivalent.

Each communication device 110-n is communicatively coupled to a communication system 115. The communication system 115, in certain embodiments, can function utilizing any wireless radio frequency (RF) channel, for example, a messaging channel, a mobile cellular telephone channel, or a mobile radio channel. Similarly, it will be appreciated by one of ordinary skill in the art that the communication system 115 can function utilizing other types of communication channels such as infrared or Bluetooth channels. In one embodiment, the communication system 115 comprises a data communication system such as a communication system utilizing packet data protocols such as TDMA (time division multiple access), GPRS (General Packet Radio Service) and EGPRS (Enhanced GPRS). In the following description, the term “communication system” refers to any of the wireless communication systems mentioned above or an equivalent.

Optionally, the communication system 115 can be communicatively coupled to another global system 120 such as the Internet (as illustrated) or any other communication system for providing a communication path among the various components of the distribution system 100. The Internet is a collection of over 25,000 computer networks connected through a communication backbone (NSFNET backbone) funded by the National Science Foundation (NSF) and is currently managed by Advanced Network System (ANS).

As illustrated in FIG. 1, a distribution center 125 is also communicatively coupled to the communication system 115. Although FIG. 1 illustrates the distribution center 125 coupled to the communication system 115 through the Internet 120, it will be appreciated by those of ordinary skill in the art that, alternatively, the distribution center 125 can be directly coupled to the communication system 115. Therefore, the communication system 115 provides a communication path between each of the point of sale locations 105-n and the distribution center 125.

The distribution center 125, for example, can be a warehouse or storage facility where the emphasis is on processing and moving goods on to wholesalers, retailers, or consumers rather than on storage. The distribution center 125 further can be a manufacturing facility that produces and distributes goods to various wholesalers, retailers, or consumers. As illustrated, the distribution center 125, in certain embodiments, includes a computing system such as a distribution center computer 130 and a distribution center server 135, the operation of each which will be described in detail hereinbelow.

The computing system within the distribution center 125 identifies the required goods for each point of sale location 105-n, thereby determining what goods to include in each delivery truck 140-n utilized for delivery of the identified goods as will be described in detail hereinbelow.

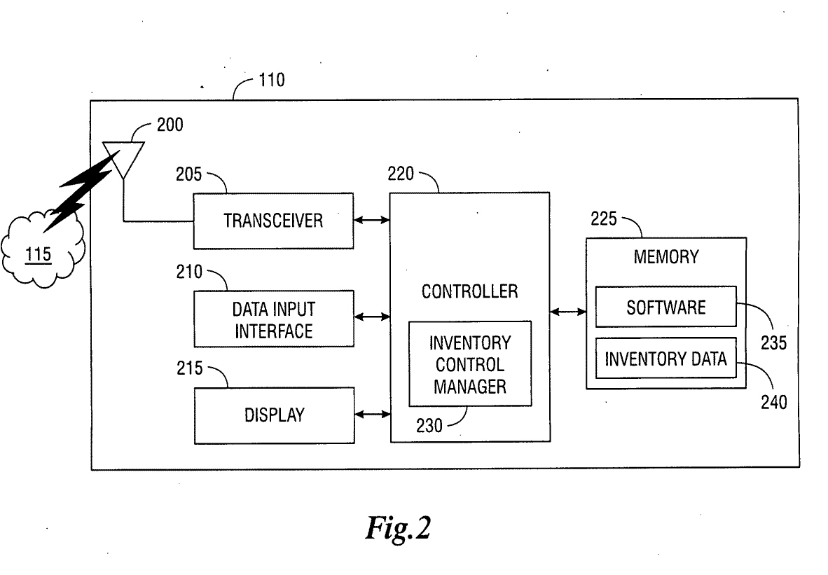

FIG. 2 is a block diagram illustrating the communication device 110 according to various embodiments. An antenna 200 intercepts transmitted signals from the communication system 115 and transmits signals to the communication system 115. The antenna 200 is coupled to a transceiver 205, which employs conventional demodulation techniques for receiving and transmitting communication signals, such as packetized signals, to and from the communication device 110 under the control of the controller 220. The packetized data signals can include, for example, voice, data or multimedia information, and packetized control signals, including inventory information. When the transceiver 205 receives a command from the controller 220, the transceiver 205 sends a signal via the antenna 200 to one or more devices communicatively operating within and/or through the communication system 115. In an alternative embodiment (not shown), the communication device 110 includes a receive antenna and a receiver for receiving signals from the communication system 115 and a transmit antenna and a transmitter for transmitting signals to the communication system 115. It will be appreciated by one of ordinary skill in the art that other similar electronic block diagrams of the same or alternate type can be utilized for the communication device 110.

Coupled to the transceiver 205 is the controller 220 utilizing conventional signal-processing techniques for processing received messages. It will be appreciated by one of ordinary skill in the art that additional processors can be utilized as required to handle the processing requirements of the controller 220.

According to various embodiments, the controller 220 includes an inventory control manager 230 for managing the inventory for the associated point of sale location 105-n of the communication device 110-n. It will be appreciated by those of ordinary skill in the art that the inventory control manager 230 can be hard coded or programmed into the communication device 110 during manufacturing, can be programmed over-the-air upon customer subscription, or can be a downloadable application. It will be appreciated that other programming methods can be utilized for programming the inventory control manager 230 into the communication device 110. It will be further appreciated by one of ordinary skill in the art that the inventory control manager 230 can be hardware circuitry within the communication device 110. In certain embodiments the inventory control manager 230 can be contained within the controller 220 as illustrated or, alternatively, can be an individual block operatively coupled to the controller 220 (not shown).

To perform the necessary functions of the communication device 110, the controller 220 and/or the inventory control manager 230 are each coupled to a memory 225, which preferably includes a random access memory (RAM), a read-only memory (ROM), an electrically erasable programmable read-only memory (EEPROM), and flash memory. The memory 225, in certain embodiments, includes storage locations for the storage of one or more software algorithms 235 and one or more inventory data 240.

It will be appreciated by those of ordinary skill in the art that the memory 225 can be integrated within the communication device 110 or, alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the communication device 110.

The communication device 110 further includes a display 215. The display 215, for example, can be a liquid crystal display utilized to display text and graphics. It will be appreciated by one of ordinary skill in the art that other similar displays such as cathode ray tube displays, organic light emitting diodes, LEDs, or plasma displays can be utilized for the display 215.

The communication device 110 further includes a data input interface 210. The data input interface 210, for example, may include, for example, a keypad, joystick or other human interface device for manual entry by an operator at the point of sale location 105. In certain embodiments, the data input interface 210 may include a bar code reader. A bar code reader (or bar code scanner) is an electronic device for reading bar codes printed on various surfaces of products. It generally consists of a light source, a lens and a photo conductor translating optical impulses into electrical ones. Additionally, nearly all bar code readers currently produced contain decoder circuitry analyzing the bar code's image data provided by the photo conductor and sending the bar code's content to the scanner's output port. In certain embodiments, the data input interface 210 may include a digital scanner or image scanner or an equivalent. It will be appreciated by those of ordinary skill in the art that the data input interface 210 may include any of the devices mentioned above or an equivalent. Further, it will be appreciated by those of ordinary skill in the art that the data input interface 210 can be incorporated within the communication device 110 or, alternatively, can be an accessory operatively coupled to the communication device 110.

Using the data input interface 210, each time the point of sale location 105 sells an item, information about items received or sold is entered into the communication device 110 via the data input interface 210. Alternatively, a store attendant can enter in the communication device 110 via the data input interface 210, the total number of each item sold and received during a specified time frame. The inventory control manager 230, using software algorithms 235 stored in the memory 225, uses the item information to calculate the total amount of each item received and/or sold during a particular time period. The calculated inventory data 240 can then be stored in the memory 225 for future use.

Further, the communication device 110, according to various embodiments, can transmit the inventory data 240, at any given time, either automatically or in response to a received message request, to the distribution center 125 via the communication system 115. The computing system of the distribution center 125 thereafter uses the received inventory data 240 to identify the item demand for the point of sale location 105, and then calculates the quantity of each item to include in the truck 140 for delivery to the point of sale location 105.

It will be appreciated that the inventory control manager 230 can prompt a user through the display 215 how and where to enter the inventory data 240 and to send such information to the distribution center 125. Alternatively, the communication device 110 can automatically send the inventory data 240 at a given time on a daily basis or other periodic time frame.

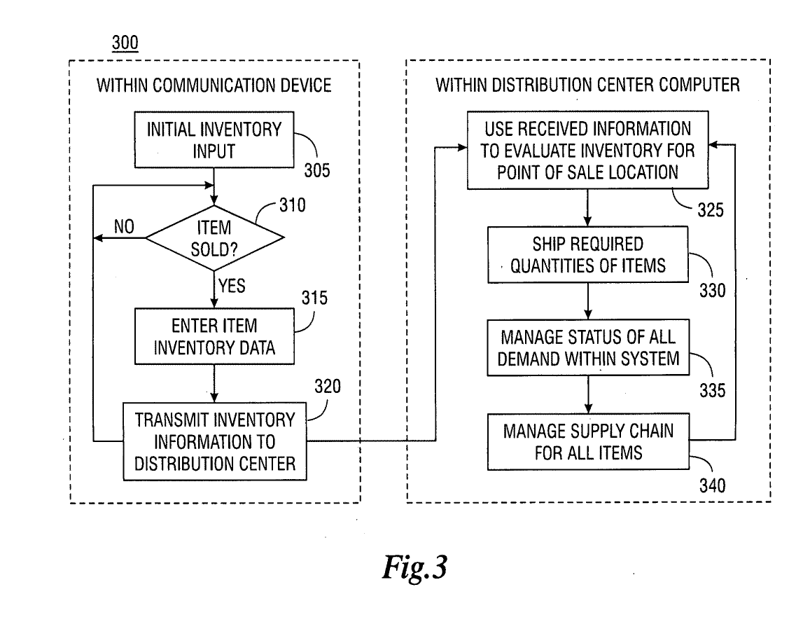

FIG. 3 is a flowchart illustrating the operation 300 of the distribution system 100 according to various embodiments. As illustrated, the operation 300 begins with Step 305 in which initial inventory information is entered into the communication device 110 at a point of sale location 105. For example, a point-of-sales (POS) manager or clerk, after choosing the option for data entry on the communication device, can be guided by a sequence of informative messages displayed on the display 215 of the communication device 110 to enter the initial inventory information. In one embodiment, the POS manager or clerk enters a secure password or other personal identification, then inputs the initial inventory data either manually or via a scanner or other data input interface as described previously herein. The inventory information, including initial quantities, is stored within the memory 225 of the communication device 110. When finished, the manager or clerk will end the input operation mode of the communication device 110. Next, in Step 310, it is determined whether or not an item has been sold. When an item has not been sold, the operation cycles back to periodically check in Step 310 for a sold item. When an item has been sold, the operation continues to Step 315 in which, after each sale, the information is entered into the communication device 110. For example, each sold product can be scanned again using the communication device 110 indicating that it has just been sold. Again, this information will be temporarily stored within the communication device 110. Next, in Step 320, at a defined interval the accumulated inventory information is transmitted to the distribution center 125 via the communication system 115. In parallel, the operation cycles back to Step 310 to continue periodically checking for sold items.

Within the distribution center 125, the operation continues to Step 325 in which the received inventory information is used to evaluate the current inventory at each of the point of sale locations 105-n. Next, in Step 330, the distribution center 125 uses the calculated current inventory of the point of sale location to identify an adequate supply of items to ship to the point of sale location. It will be appreciated that this sequence of operations will be done for all point of sale locations in the distribution system 100.

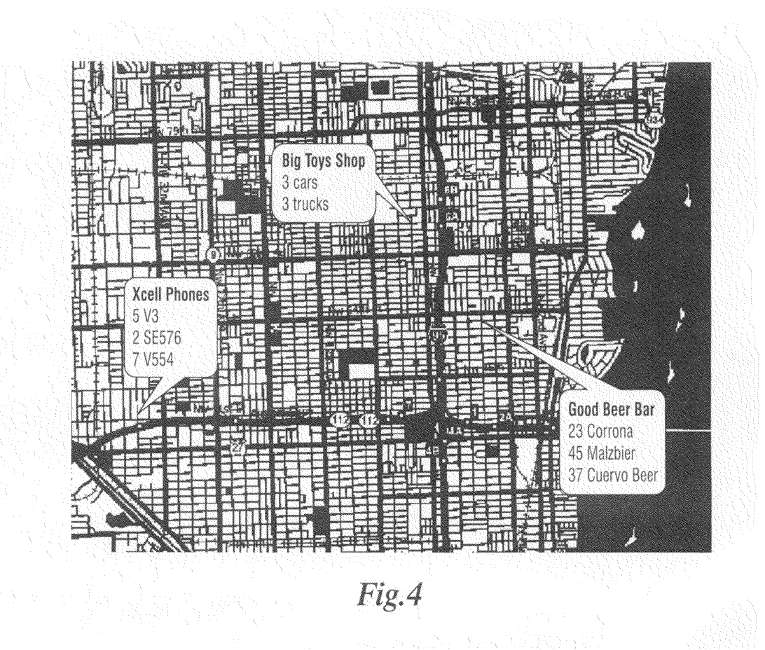

In certain embodiments, the distribution center computer 130 can include a graphic interface identifying the current inventory of each item at each point of sale location. FIG. 4 is an illustrative example of such a graphic user interface. The graphic interface can include real time verification of the status of demand for each point of sale location. The graphic interface, for example, as illustrated, can be a map with each point of sale location in the distribution system and all the relevant, decision-making information displayed. Along with the map, additional support screens with detailed information about point of sale inventory, history, best sold products, inventory aging for all products, most demanded products, average sales per periods, daily products consumption, monthly products consumption, total revenues per periods, losses, profitability per period, and any relevant information necessary to the business can be included within the graphic user interface.

Returning to FIG. 3, next, in Step 340, the distribution center 125 can use the demand information to program all suppliers within its supply chain to meet the point of sale locations' needs. The operation then cycles back to Step 325 in which the distribution center 125 continues to evaluate received demand information.

Although not illustrated, it will be appreciated that, additionally, the stored and sorted information could be sold to factories and new product developers to create demand for new products and customer adapted products.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes,” “including,” “contains,” “containing,” or any other variation thereof are intended to cover a nonexclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a,” “has . . . a,” “includes . . . a,” “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as “connected,” although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer-readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method for inventory management comprising:
within a communication device at a point of sale location:
entering an initial inventory information;
determining whether an item has been sold;
when an item has been sold, entering the sold item information into the communication device;
periodically repeating the determining of sold item and entering of sold item steps;
storing an accumulated inventory information comprising the initial inventory information and the sold item information; and
transmitting the accumulated inventory information at a defined interval to a distribution center for further processing via a communication system.

2. The method of claim 1, wherein the entering initial inventory information step comprises:
selecting an option for data entry on the communication device,
displaying a sequence of informative messages on a display of the communication device to guide a user through the entry of the initial inventory information,
inputting the initial inventory information using the sequence of informative messages as a guide, and
storing the initial inventory information including initial quantities within a memory of the communication device.

3. The method of claim 2, further comprising:
entering an identification prior to the selecting step.

4. The method of claim 3, wherein the identification comprises one of a secure password and a personal identification.

5. The method of claim 2, wherein the inputting is one of a manual input, a scanned input, and a data input interface.

6. The method of claim 2, further comprising:
ending the data entry mode of the communication device.

7. The method of claim 1, wherein the entering the sold item information comprises scanning the sold item using the communication device indicating that it has just been sold.

8. The method of claim 1, further comprising after the entering the sold item information step:
storing the sold item information within the communication device.

9. The method of claim 1, further comprising within the distribution center:
receiving the accumulated inventory information from each of a plurality of point of sale locations;
evaluating a current inventory at each of the point of sale locations using the respective received accumulated inventory information; and
identifying a demand information comprising an adequate supply of items to ship to each of the point of sale locations using the associated evaluated current inventory.

10. The method of claim 9 further comprising within the distribution center:
programming one or more suppliers within a supply chain to meet the point of sale locations' needs using the demand information.

11. The method of claim 10, further comprising within the distribution center:
periodically repeating the receiving, evaluating, identifying, and programming steps.

12. The method of claim 9, wherein the distribution center comprises a distribution center computer having a graphic interface for identifying the current inventory of each item at each point of sale location.

13. The method of claim 12, wherein the graphic interface can includes real time verification of the status of demand for each point of sale location.

14. The method of claim 13, wherein the graphic interface comprises a map with each point of sale location in the distribution system and decision-making information displayed.

15. The method of claim 14, wherein the map further comprises one or more additional support screens with detailed information about one or more of point of sale inventory, history, best sold products, inventory aging for all products, most demanded products, average sales per periods, daily products consumption, monthly products consumption, total revenues per periods, losses, and profitability per period.

16. A system for inventory management comprising:
a communication device at each of a plurality of point of sale locations, each communication device programmed to:
store an initial inventory information;
periodically determine whether an item has been sold, and when an item has been sold, store the sold item information;
store an accumulated inventory information comprising the initial inventory information and the sold item information; and
transmit the accumulated inventory information at a defined interval to a distribution center; and
a distribution center communicatively coupled to each of the communication devices, the distribution center programmed to:
receive the accumulated inventory information from each of a plurality of point of sale locations;
evaluate a current inventory at each of the point of sale locations using the respective received accumulated inventory information;
identify a demand information comprising an adequate supply of items to ship to each of the point of sale locations using the associated evaluated current inventory; and
program one or more suppliers within a supply chain to meet the point of sale locations' needs using the demand information.

17. The system of claim 16, wherein the distribution center comprises a distribution center computer having a graphic interface for identifying the current inventory of each item at each point of sale location.

18. The system of claim 17, wherein the graphic interface can includes real time verification of the status of demand for each point of sale location.

19. The system of claim 18, wherein the graphic interface comprises a map with each point of sale location in the distribution system and decision-making information displayed.

20. The system of claim 19, wherein the map further comprises one or more additional support screens with detailed information about one or more of point of sale inventory, history, best sold products, inventory aging for all products, most demanded products, average sales per periods, daily products consumption, monthly products consumption, total revenues per periods, losses, and profitability per period.
